(19) United States
(12) Patent Application Publication
(10) Pub. No.: US 2021/0396261 A1
(43) Pub. Date: Dec. 23, 2021

(54) FASTENER INCLUDING THREADS

(71) Applicant: CNH Industrial America LLC, New Holland, PA (US)

(72) Inventors: Brian D. Vik, Barnesville, MN (US); Brandon J. Smith, Casselton, ND (US)

(73) Assignee: CNH Industrial America LLC

(21) Appl. No.: 17/350,947

(22) Filed: Jun. 17, 2021

Related U.S. Application Data
(60) Provisional application No. 63/040,697, filed on Jun. 18, 2020.

(51) Int. Cl. F16B 33/02

(52) U.S. Cl. CPC F16B 33/02

(57) ABSTRACT

A fastener including a body that extends between a first end and a second end and a head that is engaged with the body at the first end. Further, the body includes a first section with a first outer diameter and a first set of threads oriented in a first direction. The body further includes a second section with a second outer diameter and a second set of threads oriented in a second direction, opposite the first direction. Also, the first section is positioned closer to the head than the second section, and the first set of threads is self-tapping.

### CROSS-REFERENCE TO RELATED APPLICATION

This application claims priority from and the benefit of U.S. Provisional Application Ser. No. 63/040,697, entitled “A FASTENER INCLUDING OPPOSING THREADS”, filed Jun. 18, 2020, which is hereby incorporated by reference in its entirety.

### BACKGROUND

The present disclosure relates generally to a fastener including threads.

Certain work vehicles have body panels that may be fastened to the chassis of the work vehicle. Typical fasteners for body panels are welded to the chassis and include a thread shaft. The threaded shaft of each fastener may extend through a respective aperture in the body panel, and a nut may be engaged with the threaded shaft to secure the body panel to the chassis. Because the fasteners are welded to the chassis, a protective coating may not be applied to the fastener and paint may not be applied to the chassis before welding. Accordingly, the chassis is typically painted after the welding process, and each fastener is covered (e.g., masked) during the painting process, thereby increasing the cost and duration of the painting process. In addition, because the protective coating may not be applied to the fastener before welding (e.g., during the fastener manufacturing process), the cost and duration associated with applying the coating may be increased.

### BRIEF DESCRIPTION

In certain embodiments, a fastener including a body that extends between a first end and a second end and a head that is engaged with the body at the first end. Further, the body includes a first section with a first outer diameter and a first set of threads oriented in a first direction. Moreover, the body includes a second section with a second outer diameter and a second set of threads oriented in a second direction such that the second direction is opposite the first direction. Also, the first section is positioned closer to the head than the second section, and the first set of threads is self-tapping.

### DRAWINGS

These and other features, aspects, and advantages of the present disclosure will become better understood when the following detailed description is read with reference to the accompanying drawings in which like characters represent like parts throughout the drawings, wherein:

FIG. 1 is a side view of an embodiment of a work vehicle that may include a fastener;

FIG. 2 is a side view of an embodiment of a fastener that may be employed within the work vehicle of FIG. 1;

FIG. 3 is a perspective view of the fastener of FIG. 2 engaged with a chassis;

FIG. 4 is a perspective view of the fastener of FIG. 2 coupling the chassis to a body panel;

FIG. 5 is a front view of an embodiment of a fastener that may be employed within the work vehicle of FIG. 1;

FIG. 6 is a side view of another embodiment of a fastener that may be employed within the work vehicle of FIG. 1; and

FIG. 7 is a top view of an embodiment of the fastener of FIG. 6.

### DETAILED DESCRIPTION

One or more specific embodiments of the present disclosure will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” “the,” and “said” are intended to mean that there are one or more of the elements. The terms “comprising,” “including,” and “having” are intended to be inclusive and mean that there may be additional elements other than the listed elements. Any examples of operating parameters and/or environmental conditions are not exclusive of other parameters/conditions of the disclosed embodiments.

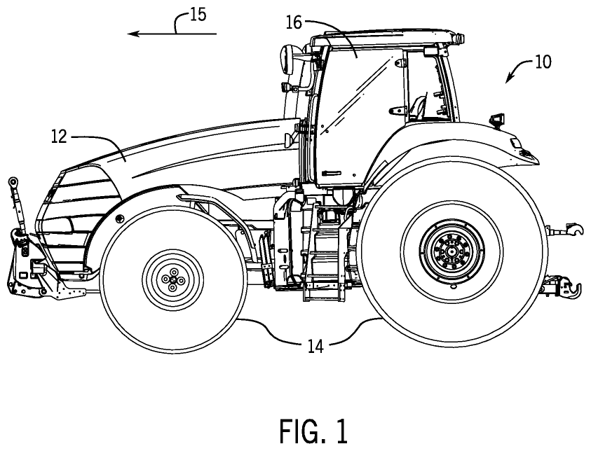

Turn now to the drawings, FIG. 1 is a side view of an embodiment of a work vehicle 10 that may include a fastener with opposing threads configured to secure a body panel to a chassis of the work vehicle 10. In the illustrated embodiment, the work vehicle 10 includes a body 12 configured to house an engine, a transmission, other systems of the work vehicle 10, or a combination thereof. In addition, the work vehicle 10 includes wheels 14 configured to be driven by the engine and transmission, thereby driving the work vehicle 10 along a field, a road, or any other suitable surface in a direction of travel 15. In the illustrated embodiment, the work vehicle 10 includes a cab 16 configured to house an operator. As discussed in detail below, the work vehicle may include a fastener with opposing threads that couples components together without welding. The fastener includes a threaded self-tapping portion so it can be utilized within unthreaded apertures. For example, if an aperture is not threaded, the threaded self-tapping portion may engage material surrounding the aperture, thereby establishing an effective connection between the fastener and the respective component.

By way of example, the threaded self-tapping portion of the fastener may be engaged with an unthreaded aperture within the chassis of the work vehicle. A second threaded portion of the fastener, which extends from the threaded self-tapping portion, may extend through an aperture in a panel of the body 12. A nut may be engaged with the second threaded portion, thereby securing the body panel to the chassis. The threads of the threaded self-tapping portion and the threads of the second threaded portion are oriented in opposing directions, such that rotation of the fastener in a direction that would cause the threaded self-tapping portion to disengage the chassis increases the engagement of the second threaded portion with the nut, thereby substantially reducing or eliminating the possibility of unintentional disengagement of the fastener (e.g., due to vibration of the work vehicle). Because the fastener may be coupled to the chassis without welding, a protective coating (e.g., zinc coating) may be applied to the fastener during the manufacturing process. As a result, the cost of the fastener/protective coating may be reduced, as compared to a fastener having a protective coating applied after the fastener is welded to the chassis (e.g., due to the labor cost associated with manually coating the fastener after welding). In addition, the chassis may be painted before the fastener is coupled to the chassis, thereby eliminating the process of masking fasteners that are welded to the chassis before painting. As a result, the manufacturing cost of the work vehicle may be reduced. While the fastener is used within the work vehicle 10 in the current embodiment, the fastener described herein may be employed within any other suitable setting that may use a fastener to secure components together, among other suitable applications.

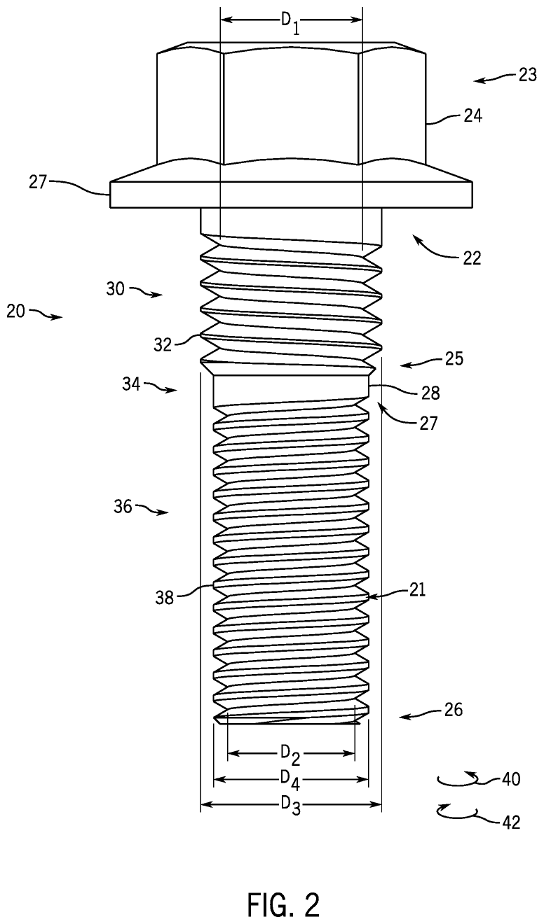

FIG. 2 is a side view of an embodiment of a fastener 20 that may be used to secure a body panel to the chassis of the work vehicle of FIG. 1. In the illustrated embodiment, the fastener 20 includes a body 28 (e.g., rod, shaft, etc.) that extends from a first end 22 to a second end 26. In addition, the fastener 20 includes a head 24 (e.g., fastening head) engaged with the first end 22 of the body 28. The head 24 may be used to tighten the fastener 20 within an aperture. In the illustrated embodiment, the head 24 includes an engagement portion 23 having engagement surfaces configured to contact corresponding engagement surface of a tool (e.g., wrench, rachet, etc.), thereby enabling the tool to rotate the fastener 20. As illustrated, the engagement portion 23 has a hexagonal shape. However, in other embodiments, the engagement portion 23 may have any other suitable shape (e.g., octagonal, elliptical, etc.) to facilitate engagement with a corresponding tool. Furthermore, in the illustrated embodiment, the head 24 includes an integral washer 27 positioned between the engagement portion 23 and the body 28. The integral washer 27 is configured to contact a respective component to distribute the load applied by the fastener over a larger area. While the integral washer 27 is circular in the illustrated embodiment, in other embodiments, the integral washer 27 may have another suitable shape (e.g., elliptical, square, etc.). Furthermore, while the head includes the engagement portion 23 and the integral washer 27 in the illustrated embodiment, in other embodiments, at least one of engagement portion 23 or the integral washer 27 may be omitted. For example, in certain embodiments, the integral washer 27 may be omitted and a separate washer may be disposed between the head of the fastener and the respective component. Furthermore, in certain embodiments, the engagement portion 23 may be omitted, and the fastener may include a recess (e.g., slot, X-shaped recess, hexagonal recess, etc.) configured to receive a respective protrusion of a tool, which may be used to drive the fastener to rotate. In addition, in certain embodiments, the head of the fastener may be omitted (e.g., a first section of the fastener may include a recess on a top portion of the first section, in which the recess is configured to receive a respective protrusion of a tool, etc.).

The body 28 of the fastener 20 also includes a first section 30 (e.g., first portion or first component), a third section 34 (e.g., third portion or third component), and a second section 36 (e.g., second portion or second component). The first section 30 is engaged with the head 24 at the first end 22 of the body 28. In addition, the first section 30 is engaged with the third section 34 at a distal 25 of the first section 30, and the third section 34 is engaged with the second section 36 at a distal end 29 of the third section 34. In some embodiments, the fastener 20 may not include a third section 34, such that the first section 30 directly engages the second section 36 at the distal 25 of the first section 30 without an intervening section.

In the illustrated embodiment, the first section 30 includes a first set of threads 32, and the second section 36 includes a second set of threads 38. The orientation of the two sets of threads are opposite one another. The first set of threads 32 are oriented such that the fastener 20 may be secured within an aperture via rotation of the fastener in a first direction 40 (e.g., counter clockwise direction or left-handed), and the second set of threads 38 are oriented such that a nut may be engaged with the fastener 20 via rotation of the nut in the first direction 40 (e.g., counter clockwise direction). In addition, rotation of the fastener 20 in a second direction 42 (e.g., clockwise direction or right-handed) drives the fastener to disengage the aperture and drives the fastener to further engage the nut. Accordingly, if vibrations induce the fastener 20 to rotate in the section direction 42, the engagement with the nut is increased. In addition, once installed, rotation of the fastener in the first direction 40 is substantially blocked by contact between the head 24 and the respective component. As such, the possibility of the fastener disengaging the respective components (e.g., the chassis and the body panel) is substantially reduced or eliminated. While the sets of threads of the fastener 20 have certain orientations in the illustrated embodiment, in other embodiments, the orientation of each set of threads may be reversed, such that the orientations of the two sets of threads are opposite one another.

A first diameter D₁ (e.g., first inner diameter) corresponds to the diameter of the first section 30 of the body 28 at the nadir of the first set of threads 32, and a second diameter D₂ (e.g., second inner diameter) corresponds to the diameter of the second section 36 of the body 28 at the nadir of the second set of threads 38. While the first diameter D₁ is larger than the second diameter D₂ in the illustrated embodiment, in other embodiments, the first diameter D₁ may be equal to or smaller than the second diameter D₂. Additionally, a third diameter D₃ (e.g., first outer diameter) corresponds to the diameter of the first section 30 of the body 28 at the peak of the first set of threads 32, and a fourth diameter D₄ (e.g., second outer diameter) corresponds to the diameter of the second section 36 of the body 28 at the peak of the second set of threads 38. In the current embodiment, the third diameter D₃ is larger than the fourth diameter D₄, but in other embodiments, the third diameter D₃ may be equal to or smaller than the fourth diameter D₄.

In the current embodiment, a protective layer 21 (e.g., coating, plating, or the like) is disposed on an outer surface of the fastener 20. For example, the protective layer 21 may be disposed on the head 24, the first section 30 (e.g., the first set of threads 32), the third section 34, the second section 36 (e.g., the second set of threads 38), or a combination thereof. In some embodiments, the protective layer 21 may substantially reduce oxidation (e.g., rust) of the fastener. In some embodiments, the protective layer 21 may substantially reduce stripping the threads. In certain embodiments, the protective layer 21 may provide a lubricant for the threads to facilitate fastening or unfastening of the fastener 20. For example, the protective layer 21 may include zinc (e.g., applied to the fastener via an electroplating process).

In the illustrated embodiment, the first set of threads 32 of the first section 30 are self-tapping, thereby enabling the first section 30 to engage material surrounding an unthreaded aperture of a component (e.g., the chassis). As a result, an effective connection between the fastener and the respective component (e.g., the chassis) may be established. For example, certain chassis may have unthreaded apertures configured to receive a shaft of a fastener without engaging the shaft, and a head of the fastener may be welded to the chassis to couple the fastener to the chassis. Because the illustrated fastener 20 includes a self-tapping first section 30, the fastener 20 may engage such an unthreaded aperture of the chassis, thereby coupling the fastener 20 to the chassis without welding. In the illustrated embodiment, the second section 36 does not include any self-tapping features (e.g., the second set of threads 38 are not self-tapping). However, in some embodiments, the second section 36 may include self-tapping feature(s). The self-tapping feature(s) may include a self-tapping tip, self-tapping threads (e.g., the second set of threads may be self-tapping), or a combination thereof. The self-tapping tip may include a drill-bit type tip (e.g., a self-drilling feature), a cutting tip, a tapered tip with cutting features, or any combination thereof. The self-tapping threads (e.g., of the first set of threads, of the second set of threads, or both) may include discontinuous threads (e.g., threads with intermediate breaks), variations in the geometry of the threads along the length of the threads, or any combination thereof. For example, the thread may periodically change in height, width, shape, angle, sharpness, or continuity along the length of the thread. The self-tapping threads may be thread-cutting (e.g., the threads remove material surrounding the aperture, thereby establishing a thread pattern within the component) and/or thread-forming (e.g., the threads may displace the material forming the aperture, thereby establishing a thread pattern within the component). The self-tapping feature(s) may facilitate self-tapping the fastener 20 into respective structure(s) (e.g., the chassis).

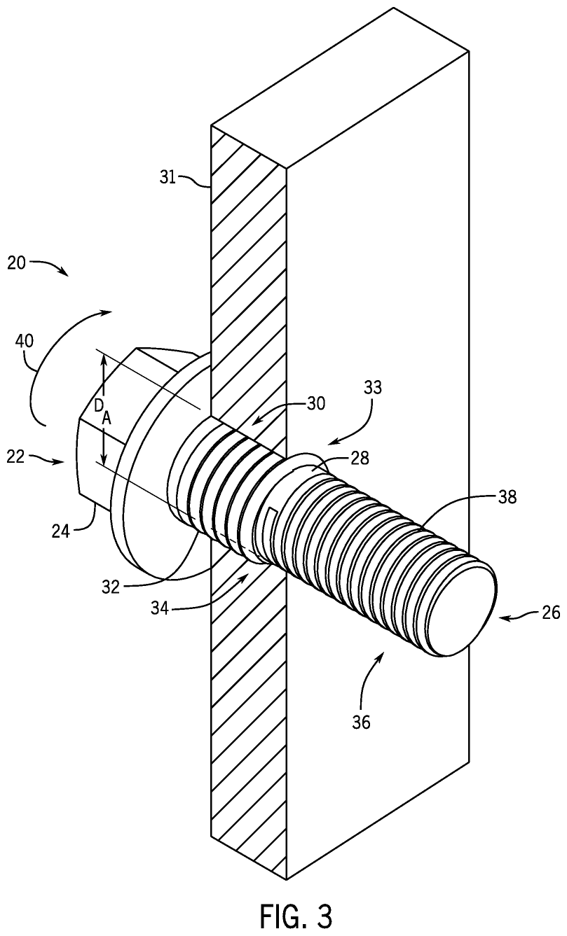

FIG. 3 is a perspective view of the fastener 20 of FIG. 2 engaged with the chassis 31 (e.g., first component) of the work vehicle. In the illustrated embodiment, the fastener 20 is inserted into an aperture 33 of the chassis 31. The aperture 33 of the chassis 31 has a diameter DA larger than the fourth diameter D₄, such that the second section 36 may pass through the aperture 33, thereby enabling the first set of threads 32 to engage the material surrounding the aperture 33. Additionally, the aperture 33 of the chassis 31 does not have existing threads. Accordingly, the self-tapping portion (e.g., the first set of threads 32 of the first section 30) may establish the connection between the fastener and the chassis. Applying a torque in direction 40 may cause the first section 30 of the fastener 20 to be secured to the chassis as the self-tapping threads engage the material surrounding the aperture 33. In some embodiments, the torque in direction 40 may be applied to the head 24 by a suitable tool (e.g., rachet, wrench, etc.).

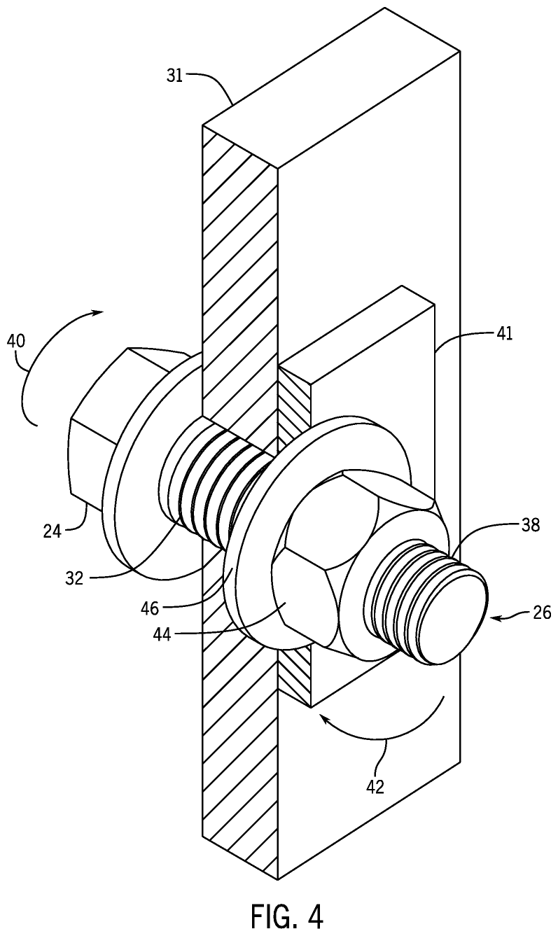

FIG. 4 is a perspective view of the fastener 20 of FIG. 2 coupling the chassis 31 (e.g., first component) to the body panel 41 (e.g., second component) of the work vehicle. As previously mentioned, the aperture 33 of first component 31 has a diameter DA larger than the fourth diameter D₄, such that the second section 36 of the body 28 may pass through the aperture 33. The first set of threads 32 may engage the material surrounding the aperture 33 of the chassis 31, thereby coupling the fastener to the chassis 31. In the illustrated embodiment, the second section 36 extends through an aperture of the body panel 41. The aperture of the body panel 41 has a diameter D_{B} larger than the fourth diameter D₄, such that the second section 36 of the body 28 may pass through the aperture of the body panel 41. In the current embodiment, a nut 44 may engage the second set of threads 38 of the second section 36 to couple the body panel 41 to the chassis 31. The nut 44 may be secured to the second set of threads 38 by applying a torque in the first direction 40 such that a washer 46, which is positioned between the nut 44 and the body panel 41, abuts the body panel 41. While the sets of threads of the fastener 20 have certain orientations in the illustrated embodiment, in other embodiments, the orientation of each set of threads may be reversed, such that the orientations of the two sets of threads are opposite one another. Although the current embodiment includes the washer 46, in certain embodiments the use of the washer 46 may be omitted. Additionally or alternatively, while the illustrated embodiment includes the nut 44, in other embodiments the nut 44 may be omitted. For example, the aperture of the body panel 41 may include a threaded connection to receive the second set of threads 38. In another example, the aperture of the body panel 41 may not include a threaded connection (e.g., an unthreaded aperture), and the second section may be self-tapping (e.g., the second section may include one or more features described herein to accomplish self-tapping), such that the second set of threads engages the material surrounding the aperture of the body panel 41, thereby establishing an effective connection between the second section and the body panel 41.

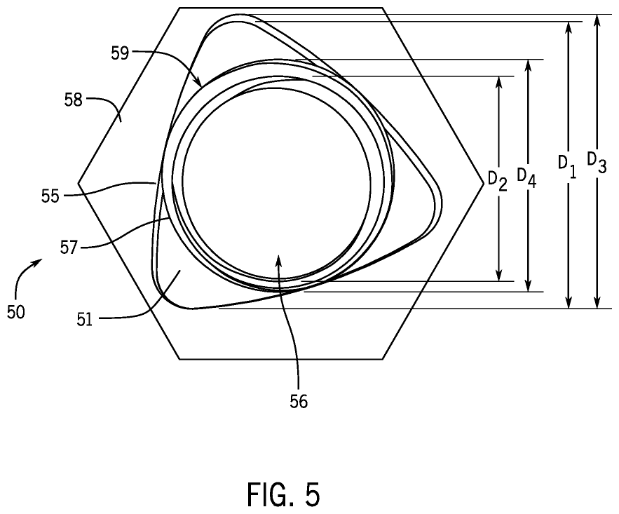

FIG. 5 is a front view of an embodiment of a fastener 50 that may be employed within the work vehicle of FIG. 1. In the illustrated embodiment, the fastener 50 includes a head 58, a first section 51 with a first set of threads 55, and a second section 56 with a second set of threads 57. The first section and the second section may be elements of a body extending between a first end and a second end (e.g., in which the head is engaged with the body at the first end). As illustrated, the first section 51 is positioned closer to the head 58 than the second section 56. Additionally, the first section 51 may have a three-lobed shape and the first set of threads 55 may be self-tapping (e.g., thread forming). Although the head 58 has a hexagonal shape in the illustrated embodiment, in other embodiments, any suitable shape or head type may be used. For example, the head may have a round shape with a countersunk tool-receiving receptacle, a hexagonal shape with an integrated washer, and the like. Furthermore, in certain embodiments, the head of the fastener may be omitted (e.g., the first section of the fastener may include a recess on a top portion of the first section, in which the recess is configured to receive a respective protrusion of a tool, etc.). In the illustrated embodiment, the first section 51 of the fastener 50 has a three-lobed shape (e.g., a curved geometric shape with a constant width and three lobes) with a first set of threads 55 disposed on the first section 51 in a first orientation. The three-lobed shape of the first section 51 may contribute to the self-tapping functionality of the first set of threads 55 (e.g., the three-lobed shape may reduce the friction between the first set of threads and the respective component during thread forming). Additionally, the three-lobed shape of the first section may provide resistance to vibrational loosening. Furthermore, the second section 56 may include one or more self-tapping features (e.g., the second set of threads 57 may be self-tapping), or the second section 56 may not include any self-tapping features.

A first diameter D₁ (e.g., a first inner diameter) corresponds to the diameter of the first section 51 at the nadir of the first set of threads 55 and may be constant throughout the shape of the first section 51. In the illustrated embodiment, the second section 56 has a rounded shape, and the second section 56 has a second set of threads 57 oriented in a second orientation, such that the second orientation is opposite of the first orientation (e.g., such that a second direction of the second threads is opposite a first direction of the first threads). Additionally, the second section 56 has a second diameter D₂ (e.g., a second inner diameter) that corresponds to the diameter of the second section 56 at the nadir of the second set of threads 57. While the first diameter D₁ is greater than the second diameter D₂ in the illustrated embodiment, in certain embodiment the first diameter D₁ and second diameter D₂ may be equal. Additionally, a third diameter D₃ (e.g., first outer diameter) corresponds to the diameter of the first section 51 at the peak of the first set of threads 55, and a fourth diameter D₄ (e.g., second outer diameter) corresponds to the diameter of the section 56 at the peak of the second set of threads 57. In the current embodiment, the third diameter D₃ is larger than the fourth diameter D₄, but In other embodiments, the third diameter D₃ may be equal to or smaller than the fourth diameter D₄.

In some embodiments, a protective layer 59 (e.g., coating, plating, or the like) is disposed on an outer surface of the fastener. For example, the protective layer 59 may be disposed on the first section 51 (e.g., the first set of threads 55), the second section 56 (e.g., the second set of threads 57), or a combination thereof. In some embodiments, the protective layer may substantially reduce oxidation (e.g., rust) of the fastener 50. In some embodiments, the protective layer may substantially reduce stripping the threads. In certain embodiments, the protective layer may provide a lubricant for the threads to facilitate fastening or unfastening of the fastener 50. For example, the protective layer 59 may include zinc (e.g., applied to the fastener via an electroplating process).

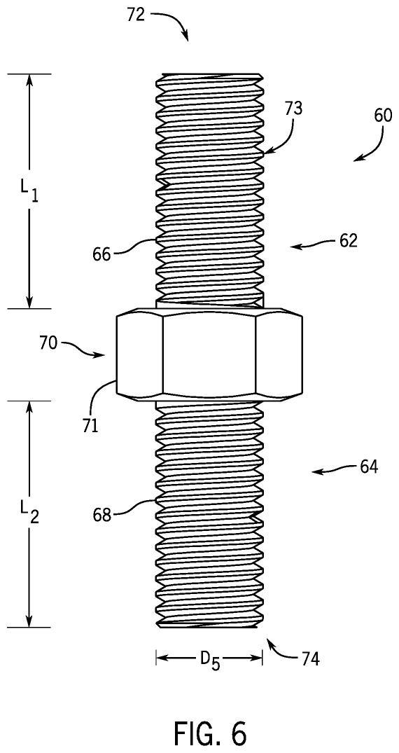

FIG. 6 is a side view of another embodiment of a fastener 60 that may be employed within the work vehicle of FIG. 1. The fastener 60 includes a first section 62, a second section 64, and a third section 70. In some embodiments the third section 70 may be omitted such that the first section 62 and second section 64 may be in direct contact. The third section 70 is in between the first section 62 and the second section 64. In some embodiments, the third section 70 may include a head 71 (e.g., fastening head), such that the head 71 may be used to tighten the fastener 60 within opposing apertures (e.g., simultaneously tightening the first section 62 in a first aperture and the second section 64 in a second aperture). Additionally or alternatively, a top portion 72 of the first section 62 may include a recess configured to receive a tool to tighten the fastener 60 within the apertures, a bottom portion 74 of the second section 64 may include a recess configured to receive a tool to tighten the fastener 60 within the apertures, or both. In some embodiments, the first section 62 includes a first set of threads 66 that are oriented in a first direction, and the second section 64 includes a second set of threads 68 that are oriented in a second direction such that the second direction is the same of the first direction. While the sets of threads of the fastener 60 have certain orientations in the illustrated embodiment, in other embodiments, the orientation of each set of threads may be reversed, such that the orientations of the two sets of threads are in the same direction. Furthermore, in certain embodiments, the second direction of the second set of threads may be opposite the first direction of the first set of threads.

In the current embodiment, the first section 62 and the second section 64 have a fifth diameter D₅ (e.g., fifth outer diameter) corresponding to diameter of the peak of the first set of threads 66 and the second set of threads 68. However, in some embodiments, the diameter of the first section 62 and the diameter of the second section 64 may be different than one another (e.g., the diameter of the first section may be greater than the diameter of the second section). In the current embodiment, a first length L₁ of the first section 62 is equal to a second length L₂ of the second section 64, but in other embodiments the first length L₁ may be different than the second length L₂.

In some embodiments, the first section 62, the second section 64, or both may be self-tapping (e.g., include one or more features described herein to accomplish self-tapping), such that the thread(s) engage material surrounding respective unthreaded aperture(s) of component(s) (e.g., the chassis and/or the body panel). As a result an effective connection between the fastener 60 and the respective component(s) may be established. Additionally or alternatively, the first section 62, the second section 64, or both may not be self-tapping (e.g., not include any features described herein to accomplish self-tapping) and may pass through aperture(s) of component(s) (e.g., the chassis and/or the body panel), and respective nut(s) may be secured to the first set of threads 66, the second set of threads 68, or both by applying torque. In certain embodiments, a washer may be positioned between each nut and the respective component and may abut the respective component.

In some embodiments, the first section 62, the second section 64, or both may have a three-lobed shape (e.g., a curved geometric shape with a constant width and three lobes). The three-lobed shape may contribute to the self-tapping functionality of the first set of threads 66, second set of threads 68, or both (e.g., the three-lobed shape may reduce the friction between the set of threads and the respective component during thread forming). Additionally, the three-lobed shape of the first section 62, second section 64, or both may provide resistance to vibrational loosening. Additionally or alternatively, the first section 62, the second section 64, or both may have a circular shape.

In some embodiments, a protective layer 73 (e.g., coating, plating, or the like) is disposed on an outer surface of the fastener. For example, the protective layer 73 may be disposed on the first section 62 (e.g., the first set of threads 66), the second section 64 (e.g., the second set of threads 68), the third section 70, or a combination thereof. In some embodiments, the protective layer may substantially reduce oxidation (e.g., rust) of the fastener 60. In some embodiments, the protective layer may substantially reduce stripping the threads. In certain embodiments, the protective layer may provide a lubricant for the threads to facilitate fastening or unfastening of the fastener 60. For example, the protective layer 73 may include zinc (e.g., applied to the fastener via an electroplating process).

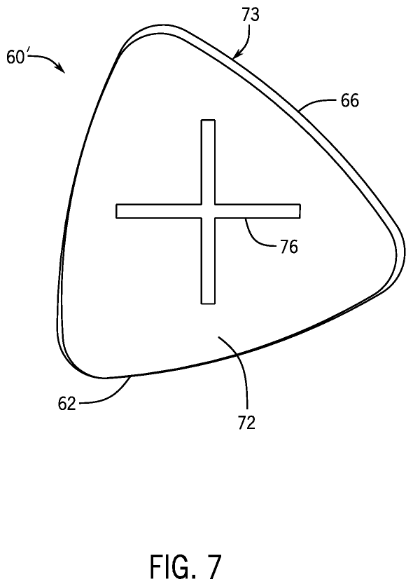

FIG. 7 is a top view of an embodiment of the fastener 60′ of FIG. 6. A top portion 72 of the first section 62 of the fastener 60′ is shown. The first section 62 of the fastener 60′ has a three-lobed shape (e.g., a curved geometric shape with a constant width and three lobes) and a first set of self-tapping threads 66. The three-lobed shape of the first section 62 may contribute to the self-tapping functionality of the first set of threads 66 (e.g., the three-lobed shape may reduce the friction between the first set of threads and the respective component during thread forming). Additionally, the three-lobed shape of the first section may provide resistance to vibrational loosening. In certain embodiments, the second section may have a round (e.g., circular) shape or may also have a three-lobed shape (e.g., in addition to self-tapping threads). The second section 64 may include one or more self-tapping features, or the second section may not include any self-tapping features.

In the illustrated embodiment, the third section or the head of the third section is omitted. In addition, the first section 62 includes a recess 76 on the top portion 72. The recess 76 is configured to receive a tool to tighten the fastener 60′ within an aperture (e.g., simultaneously tighten the first section 62 within a first aperture and the second section within a second aperture). While the recess 76 has a crossed-slot shape in the illustrated embodiment, in other embodiments, the recess 76 may have another suitable shape such that a tool may be used to tighten the fastener 60′ within an aperture. Additionally, while the recess 76 is disposed on the top portion 72 in the illustrated embodiment, in other embodiments, the recess may be omitted on the top portion 72 and included on the bottom portion, or the recess 76 may be included on both the top portion 72 and the bottom portion.

While only certain features have been illustrated and described herein, many modifications and changes will occur to those skilled in the art. It is, therefore, to be understood that the appended claims are intended to cover all such modifications and changes as fall within the true spirit of the disclosure.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ”, it is intended that such elements are to be interpreted under 35 U.S.C. 112(f). However, for any claims containing elements designated in any other manner, it is intended that such elements are not to be interpreted under 35 U.S.C. 112(f).

1. A fastener comprising:
a body extending between a first end and a second end; and
a head engaged with the body at the first end;
wherein the body comprises:
a first section having a first outer diameter and comprising a first set of threads oriented in a first direction; and
a second section having a second outer diameter and comprising a second set of threads oriented in a second direction, opposite the first direction;
wherein the first section is positioned closer to the head than the second section, and the first set of threads is self-tapping.

2. The fastener of claim 1, wherein the first outer diameter is larger than the second outer diameter.

3. The fastener of claim 1, comprising a zinc coating disposed on at least a portion of the body, at least a portion of the head, or a combination thereof.

4. The fastener of claim 1, wherein the first section has a three-lobed shape.

5. The fastener of claim 1, wherein the second section has a circular shape.

6. The fastener of claim 1, wherein the first direction is counter clockwise, and the second direction is clockwise.

7. The fastener of claim 1, wherein the head comprises an engagement portion and an integrated washer.

8. A fastener comprising:
a first section comprising a first set of threads and at least one self-tapping feature; and
a second section comprising a second set of threads, wherein the first set of threads is oriented in a first direction, and the second set of threads is oriented in a second direction;
wherein the fastener comprises a third section positioned between the first section and the second section and comprising a head, the second section does not comprise a self-tapping feature, the second direction is opposite the first direction, or a combination thereof.

9. The fastener of claim 8, wherein the first section has a three-lobed shape.

10. The fastener of claim 8, wherein the second section has a circular shape.

11. The fastener of claim 8, wherein the first section has a first outer diameter, the second section has a second outer diameter, and the first outer diameter is greater than the second outer diameter.

12. The fastener of claim 8, wherein the first section comprises a recess on a top portion of the first section, and the recess is configured to receive a tool.

13. The fastener of claim 8, wherein the at least one self-tapping feature of the first section comprises the first set of threads being self-tapping.

14. The fastener of claim 8, comprising a zinc coating disposed on at least part of the first section, at least part of the second section, or a combination thereof.

15. A fastener comprising:
a first section comprising a first set of threads oriented in a direction, wherein the first section comprises at least one self-tapping feature; and
a second section comprising a second set of threads oriented in the same direction as the first set of threads;
wherein the fastener comprises a third section positioned between the first section and the second section and comprising a head, the second section does not comprise a self-tapping feature, or a combination thereof.

16. The fastener of claim 15, comprising a zinc coating disposed on at least part of the first section, at least part of the second section, or a combination thereof.

17. The fastener of claim 15, wherein the at least one self-tapping feature of the first section comprises the first set of threads being self-tapping.

18. The fastener of claim 15, wherein the second section has a circular shape.

19. The fastener of claim 15, wherein the first section comprises a recess on a top portion of the first section, and the recess is configured to receive a tool.

20. The fastener of claim 15, wherein the first section has a three-lobed shape.
